(19) United States
(12) Patent Application Publication
(10) Pub. No.: US 2011/0093419 A1
(43) Pub. Date: Apr. 21, 2011

(54) PATTERN IDENTIFYING METHOD, DEVICE, AND PROGRAM

(76) Inventor: Lei Huang, Tokyo (JP)

(21) Appl. No.: 12/997,384

(22) PCT Filed: Jun. 5, 2009
(86) PCT No.: PCT/JP2009/060323

§ 371 Date: Dec. 10, 2010

(30) Foreign Application Priority Data
Jun. 11, 2008 (JP) 2008-152952

(51) Int. Cl. G06N 3/12; G06F 15/18

(52) U.S. Cl. 706/13

(57) ABSTRACT

The purpose is to provide a pattern identifying method, a pattern identifying device and a pattern identifying program, which able to correctly identify a pattern even in a case where an outlier is existed. The identifying method includes: reading, as data, an input pattern to be identified and a learning pattern previously prepared; computing a probability of a virtually generated virtual pattern existing between said input pattern and said learning pattern, as a first probability; computing a non-similarity of said input pattern with respect to said learning pattern, based on said first probability; and identifying whether or not said input pattern is consistent with said learning pattern, based on said non-similarity.

### TECHNICAL FIELD

The present invention relates to a pattern identifying method, a pattern identifying device and a pattern identifying program.

### BACKGROUND ART

Technologies related to identification of a pattern are applied to wide fields such as image recognition, voice recognition and data mining fields. When identifying the pattern, the pattern to be identified (referred to as “input pattern”, hereinafter) is compared with a previously prepared pattern (referred to as “learning pattern”, hereinafter) so as to determine whether or not the input pattern is consistent with the learning pattern.

It is desired to improve identifying accuracy in the technologies for identifying the pattern. However, the input pattern is not always provided in a complete state. In the input pattern, a part of components may be a value (outlier) that is not related to an inherent value. For example, in a case of the image identification, the input pattern may include an occlusion. The occlusion is an image of a portion which is inherently not an object to be compared and may cause the outlier. Also, in a case of the voice identification, a sudden short-time noise may be superposed to a voice to be identified. Such a short-time noise may easily cause the outlier.

With regard to the input pattern, noise removal is usually performed as preprocessing. However, it is very difficult to address the outlier only by the noise removal. Therefore, it is desired to provide a technique for identifying the pattern more accurately. That is, it is desired to improve a robustness of identification.

As one technique for improving the robustness, a technique is proposed, which uses a similarity or non-similarity between the input pattern and the learning pattern in order to improve an identifying performance. Patent Literature 1 (Japanese Patent Publication JP2006-39658A) discloses that identification is performed by using a sequence relationship corresponding to a non-similarity between partial images. Moreover, Patent Literature 2 (Japanese Patent Publication JP2004-341930A) discloses a technique of addressing the outlier by a vote method using a reciprocal of a distance as a similarity between the same categories. Moreover, Non-Patent Literature 3 (C. C. Aggarwal, A. Hinneburg, D. A. Keim; On the Surprising Behavior of Distance Metrics in High Dimensional Space, Lecture Notes in Computer Science, Vol. 1973, Springer, 2001) discloses that an L_{1/k} norm (k is an integer of 2 or more) is used as a distance scale in a D-dimensional space. It is described that the robustness against the noise is improved.

Meanwhile, regarding the pattern identification, there is also a problem in a dimension of the pattern. In a case where the technique relating to pattern identification is applied to the image recognition or voice recognition and the like, the number of components may increase in many cases. That is, a dimension of the input pattern may increase in many cases. If the dimension of the input pattern increases, it is known that the identifying accuracy of the pattern is lowered with the spherical concentration phenomenon (see for example, Non-Patent Literatures 1 (K. Beyer, J. Goldstein, R. Ramakrishnan, U. Shaft; When Is “Nearest Neighbor” Meaningful?, in Proceeding of the 7^{th} International Conference on Database Theory, Lecture Notes In Computer Science, vol. 1540, pp. 217-235, Springer-Verlag, London, 1999.) and 2 (Kamishima: A Survey of Recent Clustering Methods for Data Mining (part 2)—Challenges to Conquer Giga Data Sets and The Curse of Dimensionality—, The Japanese Society of Artificial Intelligence Official Jobrnal 18, No. 2, pp. 170-176, 2003)).

In order to accurately identify a pattern even in a case of a high-dimensional input pattern, a technique is adopted, which reduces a dimension of the input pattern. As the technique for reducing the dimension, for example, a principal component analysis and multidimensional scaling and the like are known. Also, in Non-Patent Literature 2, a representative method for efficiently reducing a dimension is described.

As the other related techniques as long as the inventor can know, Patent Literature 3 (Japanese Patent Publication JP2000-67294A) and Patent Literature 4 (Japanese Unexamined Patent Application Publication JP-A-Heisei 11-513152) are listed.

Citation List:

[Patent Literature 1] JP 2006-39658A

[Patent Literature 2] JP 2004-341930A

[Patent Literature 3] JP 2000-67294A

[Patent Literature 4] JP-A-Heisei 11-513152

[Non-Patent Literature 1] K. Beyer, J. Goldstein, R. Ramakrishnan, U. Shaft; When Is “Nearest Neighbor” Meaningful?, in Proceeding of the 7^{th} International Conference on Database

Theory, Lecture Notes In Computer Science, vol. 1540, pp. 217-235, Springer-Verlag, London, 1999.

[Non-Patent Literature 2] Kamishima: A Survey of Recent Clustering Methods for Data Mining (part 2)—Challenges to Conquer Giga Data Sets and The Curse of Dimensionality—, The Japanese Society of Artificial Intelligence Official Journal 18, No. 2, pp. 170-176, 2003

[Non-Patent Literature 3] C. C. Aggarwal, A. Hinneburg, D. A. Keim; On the Surprising Behavior of Distance Metrics in High Dimensional Space, Lecture Notes in Computer Science, Vol. 1973, Springer, 2001

### SUMMARY OF THE INVENTION

In order to calculate a non-similarity (similarity) between a high-dimensional (D-dimensional) input pattern X⁽¹⁾=(x⁽¹⁾₁, . . . , x⁽¹⁾_{D}) and a learning pattern X⁽²⁾=(x(⁽²⁾₁, . . . , x⁽²⁾_{D}), it is considered to use a distance between the input pattern X⁽¹⁾ and the learning pattern X⁽²⁾. In other words, it is considered that, as the larger the distance is, the lower the similarity is (i.e., the higher the non-similarity is).

As the distance d₂^{(D)} (X⁽¹⁾, . . . , X⁽²⁾) between the input pattern X⁽¹⁾ and the learning pattern X⁽²⁾, it is considered to use an L; norm represented by a following expression 1.

$$\begin{matrix}[ Expression 1 ] & \\ {d}_{2}^{( D )} ( {X}^{( 1 )} , {X}^{( 2 )} ) = \sqrt{{\sum }_{i = 1}^{D} {( {x}_{i}^{( 1 )} - {x}_{i}^{( 2 )} )}^{2}} & ( 1 )\end{matrix}$$

However, when using the L₂ norm, in the components of D-dimensional patterns, an influence exerting on the non-similarity by a component having a small distance is much smaller compared to an influence of a component having a large distance. It is assumed that an outlier is included in either of the input pattern and the learning pattern. At this time, the distance between the input pattern and the learning pattern easily becomes large in a component having the outlier. Therefore, the influence exerting on the non-similarity becomes large in the component having the outlier, and it becomes difficult to accurately identify. Moreover, if the dimension D becomes large, a probability of existence of the outlier becomes high. Therefore, it becomes further difficult to identify a pattern in the high-dimensional pattern.

As a method for reducing the influence of the outlier, it is considered to use an L_{1/k} norm (k is an integer of 2 or more) that is represented by the following expression 2, as a distance d_{1/k}^{(D) (X}⁽¹⁾, X⁽²⁾) between the D-dimensional input pattern X⁽¹⁾=(x⁽¹⁾₁, . . . , x⁽¹⁾_{D}) and the learning pattern X⁽²⁾=(x⁽²⁾₁, . . . , x⁽²⁾_{D}).

$$\begin{matrix}[ Expression 2 ] & \\ {d}_{1 / k}^{( D )} ( {X}^{( 1 )} , {X}^{( 2 )} ) = {( {\sum }_{i = 1}^{D} {( {x}_{i}^{( 1 )} - {x}_{i}^{( 1 )} )}^{1 / k} )}^{k} & ( 2 )\end{matrix}$$

In the case where an L_{α} norm (α is a positive real number) is used as the distance, the smaller α is, the higher the robustness becomes, in the identification. This is because, the smaller α is, the smaller the influence by the component having a large distance becomes so that the influence by the outlier becomes relatively small. By using the L_{1/k} norm as the distance, the influence exerted on the non-similarity by the outlier is reduced and it is considered that it is facilitated to accurately identify a pattern even in the case of the high-dimensional pattern.

However, even in the case of using the L_{1/k} norm, it was still difficult to completely eliminate the influence of the outlier.

Therefore, an object of the present invention is to provide a pattern identifying method, a pattern identifying device and a pattern identifying program, which able to accurately identify a pattern even in the case where the outlier exists.

A pattern identifying method according to the present invention includes: reading, as data, an input pattern to be identified and a learning pattern previously prepared; computing, as a first probability, a probability of a virtually generated virtual pattern existing between the input pattern and the learning pattern; computing a non-similarity of the input pattern with respect to the learning pattern based on the first probability; and identifying whether or not the input pattern is consistent with the learning pattern based on the non-similarity.

A pattern identifying program according to the present invention is a program for a computer executing the steps of: reading, as data, an input pattern to be identified and a learning pattern previously prepared; computing, as a first probability, a probability of a virtually generated virtual pattern existing between the input pattern and the learning pattern; computing a non-similarity based on the first probability; and identifying whether or not the input pattern is consistent with the learning pattern based on the non-similarity.

A pattern identifying device according to the present invention includes: data input means adapted to read, as data, an input pattern to be identified and a learning pattern previously prepared; first probability computing means adapted to compute, as a first probability, a probability of a virtually generated virtual pattern existing between the input pattern and the learning pattern; non-similarity computing means adapted to compute a non-similarity based on the first probability; and identifying means adapted to identify whether or not the input pattern is consistent with the learning pattern based on the non-similarity.

According to the present invention, a pattern identifying method, a pattern identifying device and a pattern identifying program are provided, which can accurately identify a pattern even in the case where the outlier exists.

### BRIEF DESCRIPTION OF DRAWINGS

FIG. 1 is a schematic block diagram showing a pattern identifying device according to a first embodiment;

FIG. 2 is a flow chart showing a pattern identifying method according to the first embodiment;

FIG. 3 is a flow chart showing the pattern identifying method according to the first embodiment; and

FIG. 4 is a schematic block diagram showing a pattern identifying device according to a second embodiment.

### DESCRIPTION OF EMBODIMENTS

### First Exemplary Embodiment

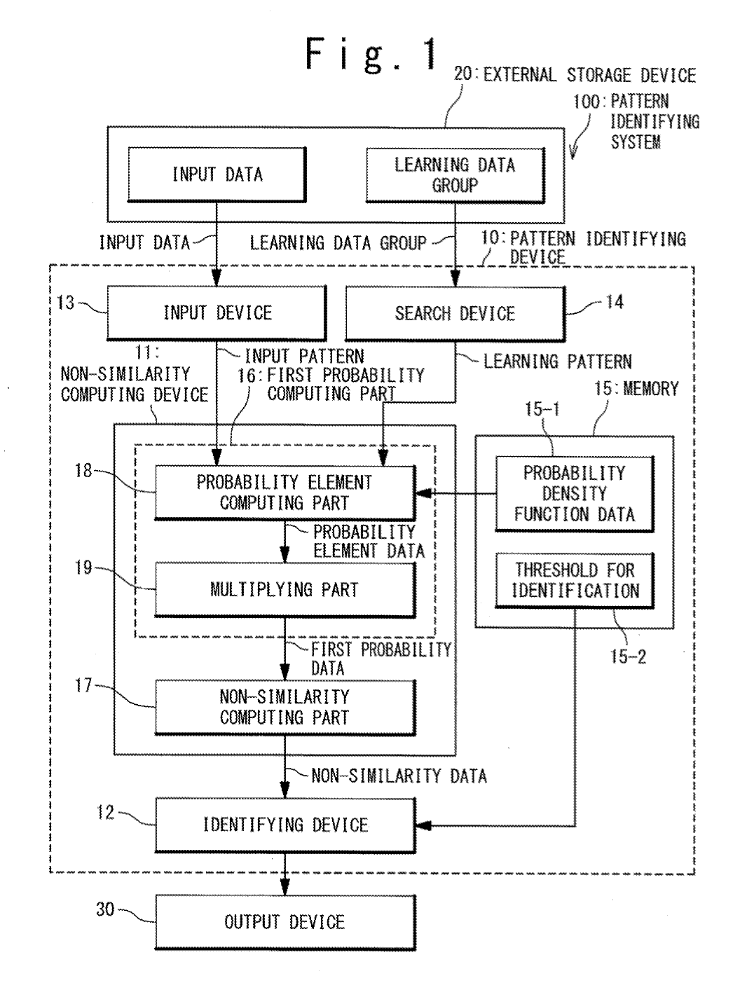

FIG. 1 is a schematic block diagram showing a pattern identifying system according to the present exemplary embodiment. This pattern identifying system includes a pattern identifying device 10, an external storage device 20 and an output device 30.

Input data and a learning data group are stored as data in the external storage device 20. The input data indicates a target pattern to be identified. The learning data group indicates learning patterns. The learning patterns are patterns to be compared to the input pattern as references of identification. The learning data group includes a plurality of pieces of learning data in a list. The external storage device 20 includes, for example, a hard disc and the like.

The pattern identifying device 10 is provided for identifying a learning pattern that is consistent with the input pattern. The pattern identifying device 10 includes an input device 13, a search device 14, a non-similarity computing device 11, a memory 15 for storing various kinds of data and an identifying device 12. The input device 13, the search device 14, the non-similarity computing device 11 and the identifying device 12 are realized by a pattern identifying program that is stored in a ROM (Read Only Memory) and the like.

The input device 13 is provided for reading the input pattern. The input device 13 extracts a plurality of feature (component) based on the input data. Then, a feature value x of each component is obtained to generate an input pattern X⁽¹⁾=(x⁽¹⁾₁, . . . , x⁽¹⁾_{D}). The generated input pattern X⁽¹⁾ is read into the pattern identifying device 10. In the input pattern X⁽¹⁾=(x⁽¹⁾₁, . . . , x⁽¹⁾_{D}, x⁽¹⁾ₙ (n is a positive integer) indicates a feature value x of a n^{th} component. D indicates the number of the components, namely, indicates that the dimension of the input pattern X⁽¹⁾ is D.

The search device 14 is provided for reading the learning pattern from the learning pattern group. The search device 14 searches learning data from the learning data group. Then, the search device 14 extracts a plurality of features (components) based on the searched learning data, similarly to the input device 13. Then, the search device 14 obtains a feature value of each component and generates a D-dimensional learning pattern X⁽²⁾=(x⁽²⁾₁, . . . , x⁽²⁾_{D}). The generated learning pattern X⁽²⁾ is read into the pattern identifying device 10.

The non-similarity computing device 11 is provided for computing a non-similarity between the input pattern X⁽¹⁾ and the learning pattern X⁽²⁾. The non-similarity computing device 11 includes a first probability computing part 16 and a non-similarity computing part 17. The first probability computing part 16 includes a probability element computing part 18 and a multiplying part 19.

The identifying device 12 is provided for identifying whether or not the input pattern X⁽¹⁾ is consistent with the learning pattern X⁽²⁾, based on the non-similarity.

In the memory 15, probability density function data 15-1 and a threshold 15-2 for identification are previously stored.

The probability density function data 15-1 is data that indicates probability density function q(x). The probability density function q(x) is a function of the feature value x, and indicates a probability of existence of the data when the data is randomly generated within a domain. The probability density function data 15-1 indicates a probability density function for each of D pieces of components. That is, the probability density function data 15-1 indicates probability density functions q₁ (x₁), . . . , and q_{d}(x_{D}), regarding to the D pieces of components.

The threshold 15-2 is data indicating a value that is used as a reference when identifying whether or not the input pattern is consistent with the learning pattern.

The output device 30 is exemplified as a display device having a display screen or the like. An identified result by the pattern identifying device 10 is outputted to the output device 30.

Subsequently, a pattern identifying method according to the present exemplary embodiment will be explained below.

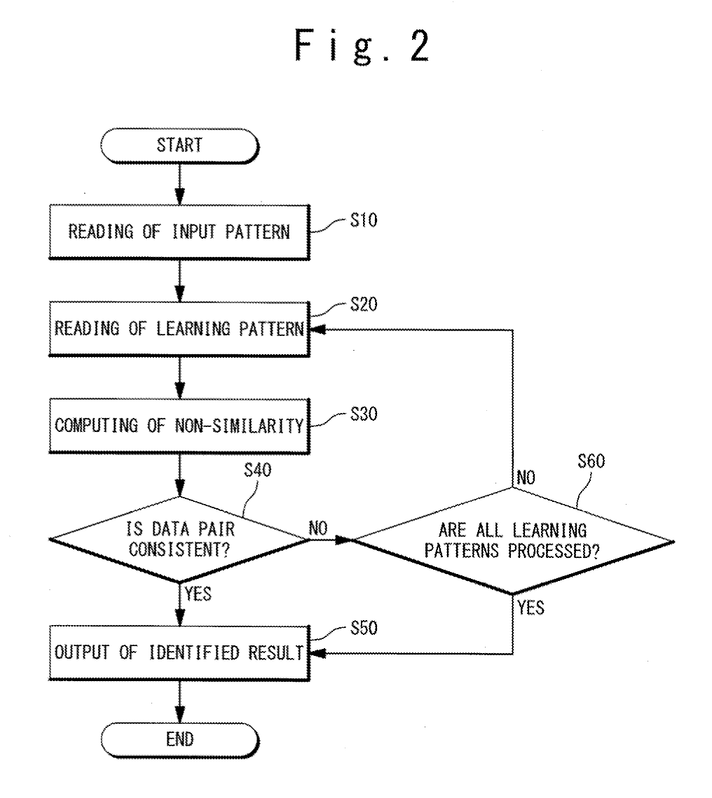

FIG. 2 is a flow chart showing the pattern identifying method according to the present exemplary embodiment.

Step S10: Reading of Input pattern

Initially, the input data stored in the external storage device 20 is read into the pattern identifying device 10 via the input device 13. The input device 13 extracts a plurality (D pieces) of features (components) based on the input data. Then, the feature value x of the each component is obtained to generate the input pattern X⁽¹⁾=(x⁽¹⁾₁, . . . , x⁽¹⁾_{D}). The generated input pattern X⁽¹⁾ is read into the pattern identifying device 10.

Step S20: Reading of Learning Pattern

Next, the search device 14 reads a learning pattern from the learning data group stored in the external storage device 20 into the pattern identifying device 10. The search device 14 extracts a plurality (D pieces) of component based on the learning data, similarly, to the input device 14. Then, the feature value of the each component is obtained to generate the learning pattern X⁽²⁾=(x⁽²⁾₁, . . . , x⁽²⁾_{D}). The generated learning pattern X⁽²⁾ is read into the pattern identifying device 10.

Step S30: Computation of Non-similarity

Subsequently, the non-similarity computing device 11 computes a non-similarity between the input pattern X⁽¹⁾ and the learning pattern X⁽²⁾. The process in the present step will be described later.

Step S40: Is Data Pair Consistent?

Subsequently, the identifying device 12 compares the non-similarity with the threshold 15-2 stored in the memory 15. The identifying device 12 determines whether or not the input pattern is consistent with the learning pattern, based on the comparison result.

Step S50: Output of Identified Result

In Step S40, when the input pattern is consistent with the learning pattern, the identifying device 12 outputs, via the output device 30, the fact that the input patter is consistent with the learning pattern.

Step S60: Are All Learning Patterns Processed?

Meanwhile, in Step S40, when the input pattern is not inconsistent with the learning pattern, a next learning pattern is read from the learning data group of the external storage device 20 by the search device 14, and the processes in Step S20 and subsequent steps are repeated. In a case where the all learning data of the learning data group has been processed, the identifying device 12 outputs, via the output device 30, the fact that there is no consistent learning pattern.

By a series of the processes described above, the learning pattern is identified that is consistent with the input pattern.

In the present exemplary embodiment, the process in the step (Step S30) of computing the non-similarity is devised.

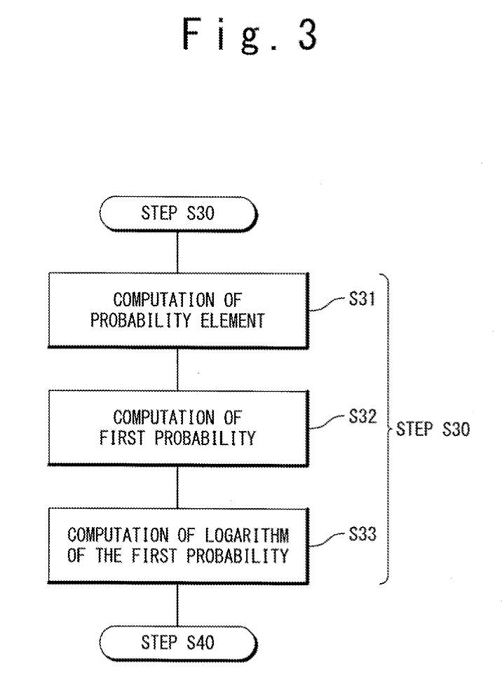

FIG. 3 is a flow chart specifically showing an operation of Step S30. In Step S30, the first probability computing part 16 computes a probability of a virtually generated pattern X⁽³⁾=(x⁽³⁾₁, . . . , x⁽³⁾_{D}) (referred to as “virtual pattern”, hereinafter) existing between the input pattern X⁽¹⁾ and the learning pattern X⁽²⁾, as the first probability (Steps S31 and S32). Then, the non-similarity computing part 17 computes a logarithm of the first probability, as the non-similarity (Step S33). The following further specifically describes the process, of each step.

Step S31: Computation of Probability Component

Initially, regarding the each of the D-dimensional components, the probability component computing part 18 computes a probability of the virtual pattern X⁽³⁾ existing between the input pattern X⁽¹⁾ and the learning pattern X⁽²⁾, as a probability element p (x⁽¹⁾ᵢ, x⁽²⁾ᵢ). This probability element p (x⁽¹⁾ᵢ, x⁽²⁾ᵢ) is computed by using the probability density function qᵢ (xᵢ). That is, regarding an i^{th} component xᵢ, the probability element p (x⁽ⁱ⁾ᵢ, x⁽²⁾ᵢ) is obtained by the following expression 3.

[Expression 3]

p(xᵢ⁽¹⁾, xᵢ⁽²⁾)=∫ₘᵢₙ₍ₓ_{ᵢ}_{⁽¹⁾}_{,x}_{ᵢ}_{⁽²⁾}₎^{max(x}^{ᵢ}^{⁽¹⁾}^{,x}^{ᵢ}^{⁽²⁾}⁾qᵢ(x)dx (3)

Step S32: Calculation of Product

Subsequently, the product calculating part 19 computes a probability of the all of the D pieces of components in the virtual pattern X⁽³⁾ existing between the input pattern X⁽¹⁾ and the learning pattern X⁽²⁾, as the first probability P (X⁽¹⁾, X⁽²⁾). This first probability P (X⁽¹⁾, X⁽²⁾) can be computed by obtaining a product of the probability elements p (x⁽¹⁾₁, x⁽²⁾ᵢ) obtained in Step S31. That is, the first probability P X⁽²⁾ can be computed by the following expression 4.

$$\begin{matrix}[ Expression 4 ] & \\ P ( {X}^{( 1 )} , {X}^{( 2 )} ) = {\prod }_{i = 1}^{D} p ( {x}_{i}^{( 1 )} , {x}_{i}^{( 2 )} ) & ( 4 )\end{matrix}$$

The obtained first probability P (X⁽¹⁾, X⁽²⁾) indicates a probability of the virtual pattern X⁽³⁾ randomly given in a domain of the input pattern X⁽¹⁾ incidentally existing between the input pattern X⁽¹⁾ and the learning pattern X⁽²⁾. Hence, it can be said that, the smaller this first probability P, the smaller the difference between the input pattern X⁽¹⁾ and the learning pattern X⁽²⁾. In this case, it is concluded that the input pattern X⁽¹⁾ and the learning pattern X⁽²⁾ are similar patterns.

Step S33: Computation of Non-similarity

Next, the non-similarity computing part 17 computes a logarithm of the first probability P (X⁽¹⁾, X⁽²⁾) as a non-similarity E^{(D)} (X⁽¹⁾, X⁽²⁾). That is, the non-similarity computing part 17 computes the non-similarity E^{(D)}(X⁽¹⁾, X⁽²⁾) by the following expression 5.

[Expression 5]

E^{(D)}(X⁽¹⁾,X⁽²⁾)=ln P(X⁽¹⁾, X⁽²⁾) (5)

By the processes of Steps S31 to S33 as described above, the non-similarity E^{(D)} (X⁽¹⁾, X⁽²⁾) between the input pattern X⁽¹⁾ and the learning pattern X⁽²⁾ is computed. Since the computed non-similarity is a logarithm of a probability, it becomes a non-positive value. Also, the larger the first probability P (X⁽¹⁾, X⁽²⁾) is, the larger the non-similarity E^{(D)} (X⁽¹⁾, X⁽²⁾) becomes, and it is represented that the non-similarity is large (i.e., the similarity is small).

Subsequently, an effect of the present exemplary embodiment will be explained.

When a distance between the input pattern X⁽¹⁾ and the learning pattern X⁽²⁾ is small, the non-similarity E^{(D)} (X⁽¹⁾, X⁽²⁾) obtained in the present exemplary embodiment becomes a small value. Regarding this point, it is similar to the case where the non-similarity is calculated based on a distance L_{1/k} norm (see Expression 2) between the input pattern and the learning pattern.

However, whereas the L_{1/k}(norm is a non-negative value, the non-similarity of the present exemplary embodiment is a non-positive value. In the case where the L_{1/k} norm is used as the non-similarity, a penalty is imposed to the similarity in a component having a large distance such as the outlier. That is, if k is set to be a large value, an influence exerted on the similarity (non-similarity) by an outlier component becomes smaller than that in the case of setting k to be small. However, among the D pieces of components, the outlier component is still large in the influence on the non-similarity.

Contrary to this, in the present exemplary embodiment, in a component having a small distance, the similarity is added in point. Therefore, among the D pieces of components, the outlier component easily becomes smallest in the influence on the non-similarity. This point is explained below.

Contribution by the probability element p (x⁽¹⁾ᵢ, x⁽²⁾ᵢ) of the i^{th} component on the non-similarity is defined as Ei (X⁽¹⁾, X⁽²⁾). Moreover, it is assumed that the non-similarity E^{(D)} (X⁽¹⁾, X⁽²⁾) can be given as a sum of the contribution Ei (X⁽¹⁾, X⁽²⁾) of the all components. That is, it is assumed that the following expression 6 can be established between the non-similarity E^{(D)} (X⁽¹⁾, X⁽²⁾) and the contribution Ei (X⁽¹⁾, X⁽²⁾).

$$\begin{matrix}[ Expression 6 ] & \\ {E}^{( D )} ( {X}^{( 1 )} , {X}^{( 2 )} ) = {\sum }_{i = 1}^{D} {E}_{i} ( {X}^{( 1 )} , {X}^{( 2 )} ) & ( 6 )\end{matrix}$$

Herein, the following expression 7 can be established based on the expressions 4 to 6.

$$\begin{matrix}[ Expression 7 ] & \\ \begin{matrix}{E}^{( D )} ( {X}^{( 1 )} , {X}^{( 2 )} ) = ln P ( {X}^{( 1 )} , {X}^{( 2 )} ) \\ = ln ( {\prod }_{i = 1}^{D} p ( {x}_{i}^{( 1 )} , {x}_{i}^{( 2 )} ) ) \\ = {\sum }_{i = 1}^{D} {E}_{i} ( {X}^{( 1 )} , {X}^{( 2 )} )\end{matrix} & ( 7 )\end{matrix}$$

According to the expression 7, the contribution Ei (X⁽¹⁾, X⁽²⁾) of the i^{th} component can be represented by the following expression 8.

[Expression 8]

Eᵢ(X⁽¹⁾,X⁽²⁾)=ln p(xᵢ⁽¹⁾,xᵢ⁽²⁾) (8)

Referring to the expression 8, since the contribution Ei (X⁽¹⁾, X⁽²⁾) of the i^{th} component is a logarithm of a probability, it is understood that the contribution is 0 or a negative value all the time. That is, it is understood that the following expression 9 can be established.

[Expression 9]

Eᵢ(X⁽¹⁾,X⁽²⁾)=ln p(xᵢ⁽¹⁾,xᵢ⁽²⁾)≦0 (9)

In the component having the outlier, there is a large difference between the input pattern X⁽¹⁾ and the learning pattern X⁽²⁾ in the feature value. Therefore, the probability element p (x⁽¹⁾ᵢ, x⁽²⁾ᵢ) becomes large. Hence, the contribution Ei (X⁽¹⁾, X⁽²⁾) of the component having the outlier becomes large. However, the contribution Ei (X⁽¹⁾, X⁽²⁾) is 0 or a negative value (non-positive value) and an absolute value of Ei (X⁽¹⁾, X⁽²⁾) becomes small. The fact that the absolute value of the Contribution Ei (X⁽¹⁾, X⁽²⁾) is small means that an influence on the non-similarity, that is a computed result, is small. That is, in the all components, the component having the outlier easily becomes smallest in the influence on the non-similarity. Whereas, in the case of a similar component, the probability element p (x(⁽¹⁾ᵢ, x⁽²⁾ᵢ) becomes small and the absolute value of the contribution Ei (X⁽¹⁾, X⁽²⁾) easily becomes large. That is, the influence on the computed result of the non-similarity easily becomes large.

As described above, according to the present exemplary embodiment, among the D pieces of components, the component having the outlier is a small in the influence on the non-similarity. Thus, a pattern can be identified even when the pattern is a high-dimensional pattern. By this feature, even in an image identification having, e.g., an occlusion, it becomes possible to reduce the contribution of the occlusion portion that is essentially not to be compared.

### Second Exemplary Embodiment

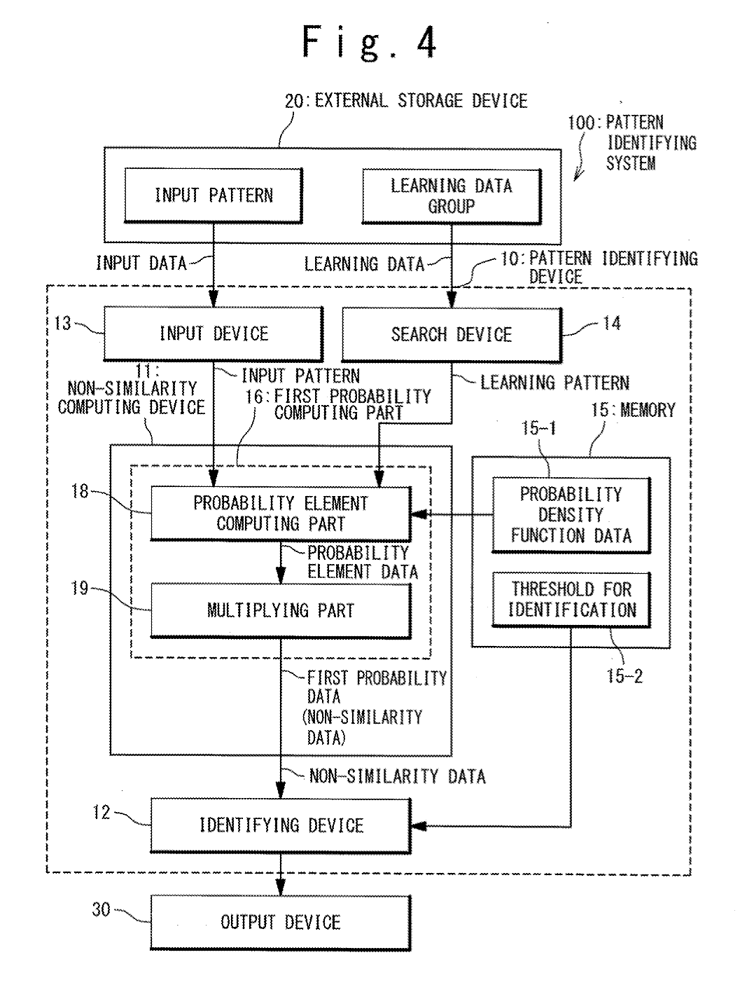

Subsequently, a second exemplary embodiment of the present invention will be explained. FIG. 4 is a schematic block diagram showing a configuration of a pattern identifying device according to the present exemplary embodiment. In the present exemplary embodiment, the non-similarity computing part is deleted in comparison with the first exemplary embodiment. The other points can be same as those of the first exemplary embodiment, and the detailed explanation thereof is omitted here.

In the present exemplary embodiment, the step (Step S30) of computing a non-similarity in the first exemplary embodiment is modified. That is, in the present exemplary embodiment, the first probability itself is treated as the non-similarity.

Even if the first probability itself is used, the non-similarity can reflect a degree of the similarity (non-similarity) between the input pattern X⁽¹⁾ and the learning pattern X⁽³⁾.

When the first probability itself is used as the non-similarity, it can be said that the threshold for identification indicates a probability of the input pattern being determined to be consistent with the learning pattern. although the input pattern is inherently not inconsistent with the learning pattern. Therefore, when determining the threshold for identification, an expected error rate itself can be used. For example, in a case where the expected error rate is 0.01%, the threshold for identification may be set to 0.01%. Thus, according to the present exemplary embodiment, it is facilitated to set a parameter in the pattern identifying device.

### Third Exemplary Embodiment

Subsequently, a third exemplary embodiment of the present invention will be explained. In the present exemplary embodiment, the process of the non-similarity computing device 11 (the process in Step S30 for computing a non-similarity) is further devised in comparison with the exemplary embodiments mentioned above. The other points can be same as those of the exemplary embodiments mentioned above, and the detailed explanation thereof will be omitted.

In a finger printing identification and the like, data of a part of features (components) is lost in the input pattern in many cases. If the data is lost, it may be difficult to calculate the non-similarity.

For example, the method of using the L_{1/k} norm (see Expression 2) is unsuitable for a pattern identification when a missing value exists. It is assumed that a distance d_{1/k}^{(D)} (X⁽¹⁾, X⁽²⁾) between a D-dimensional input pattern X⁽¹⁾=(x⁽¹⁾₁, . . . , x⁽¹⁾_{D}) and a learning pattern X⁽²⁾=(x⁽²⁾₁, . . . , x⁽²⁾_{D}) is obtained by using the L_{1/k} norm. Also, with respect to a (D-d)-dimensional input pattern wherein d pieces of components are excluded as missing values from the D-dimensional input pattern, it is assumed that a distance d_{1/k}^{(D-d)} (X^{(1)′}, X^{(2)′}) from the learning pattern X⁽²⁾ is obtained. Then, it is assumed that the distance d_{1/k}^{(D)} (X⁽¹⁾, X⁽²⁾) and the distance d_{1/k}^{(D-d)} (X^{(1)′}, X^{(2)′}) are compared. The comparison result is d_{1/k}^{(D-d)} (X^{(1)′}, X^{(2)′})≦d_{1/k}^{(D)} (X⁽¹⁾, X⁽²⁾). That is, in the case where the missing value exists, the distance between the input pattern and the learning pattern becomes small, and the input pattern is determined to be similar to the learning pattern.

Therefore, in the present exemplary embodiment, there is made a device for handling the missing value.

In the present exemplary embodiment, when a value of a certain component is a missing value in the input pattern X⁽¹⁾ or the learning pattern X⁽²⁾, the probability element computing part 18 computes the probability element p (x⁽¹⁾ᵢ, x⁽²⁾ᵢ) of the component as 1 (see expression 10 as below).

[Expression 10]

p(xᵢ⁽¹⁾, xᵢ⁽²⁾)=1 (10)

Thus, a contribution of a probability element of the missing value component exerting on the non-similarity becomes zero (see expression 11 as below).

[Expression 11]

Eᵢ(X⁽¹⁾, X⁽²⁾)=0 (11)

Accordingly, a non-similarity E^{(D)} (X⁽¹⁾, X⁽²⁾) between two D-dimensional patterns X⁽¹⁾ and X⁽²⁾ including no missing value always becomes smaller than a non-similarity E^{(D-d)} (X^{(1)′}, X^{(2)′}) between (D-d)-dimensional patterns X^{(1)′} and X^{(2)′} excluding d pieces of components as the missing values. Therefore, the similarity becomes smaller in the case where the missing value exists. Thus, different from a case of using the L_{1/k} norm, the property of E^{(D-d)} (X^{(1)′}, X^{(2)′})≧E^{(D)} (X⁽¹⁾, X⁽²⁾) can be imparted to the non-similarity. For example, even in the case where it may be considered that a feature value of a part of the input pattern is lost, such as case of e.g. a finger printing identification and the like, it becomes possible to determine that the case having no data loss is rather similar.

### Fourth Exemplary embodiment

Subsequently, a fourth exemplary embodiment of the present invention will be explained. In the present exemplary embodiment, the probability density function data 15-1 is modified in comparison with the exemplary embodiments mentioned above. In the above-mentioned exemplary embodiments, as the probability density function, a function is provided that indicates a probability of existence of data that is randomly generated in a domain. On the other hand, in the present exemplary embodiment, the probability density function is a function that indicates a probability of existence of data that is generated so as to be uniformly distributed within the domain.

As in the present exemplary embodiment, also by using a uniform distribution function as the probability density function, functions same as the exemplary embodiments mentioned above can be obtained.

This application is based on the Japanese Patent Application No. 2008-152952 filed on Jun. 11, 2008, claiming the right of priority by this application and the disclosure thereof is entirely incorporated herein by reference.

1. A pattern identifying method, comprising:
reading, as data, an input pattern to be identified and a learning pattern previously prepared;
computing a probability of a virtually generated virtual pattern existing between said input pattern and said learning pattern, as a first probability;
computing a non-similarity of said input pattern with respect to said learning pattern; based on said first probability; and
identifying whether or not said input pattern is consistent with said learning pattern, based on said non-similarity.

2. The pattern identifying method according to claim 1, wherein said computing the non-similarity comprises:
computing a logarithm of said first probability as said non-similarity.

3. The pattern identifying method according to claim 1, wherein said computing the non-similarity comprises:
computing said first probability itself as said non-similarity.

4. The pattern identifying method according to claim 1, wherein each of said input pattern, said learning pattern and said virtual pattern is a multidimensional pattern that includes a plurality of component,
said computing the first probability comprises:
computing a probability of said virtual pattern existing between said input pattern and said learning pattern for each of said plurality of component, as a probability element; and
computing a product of said probability element in said plurality of component, as said first probability, and
said computing said probability element comprises:
deciding the probability element corresponding to i^{th} component as 1, when said input pattern or said learning pattern is lost in said i^{th} component.

5. The pattern identifying method according to claim 4, wherein said computing said probability element comprises:
computing said probability element, based on a probability density function that is previously prepared for each of said plurality of component.

6. The pattern identifying method according to claim 5, wherein said probability density function is a function that indicates a probability of existence of randomly generated data.

7. The pattern identifying method according to claim 5, wherein said probability density function is a function that indicates a probability of existence of data that is generated to be distributed with uniformity.

8. A pattern identifying program for making a computer execute a method which comprises:
reading, as data, an input pattern to be identified and a learning pattern previously prepared;
computing a probability of a virtually generated virtual pattern existing between said input pattern and said learning pattern, as a first probability;
computing a non-similarity of said input pattern with respect to said learning pattern, based on said first probability; and
identifying whether or not said input pattern is consistent with said learning pattern, based on said non-similarity.

9. The pattern identifying program according to claim 8, wherein said computing the non-similarity comprises:
computing a logarithm of said first probability as said non-similarity.

10. The pattern identifying program according to claim 8, wherein said computing the non-similarity comprises:
computing said first probability itself as said non-similarity.

11. The pattern identifying program according to claim 8, wherein each of said input pattern, said learning pattern and said virtual pattern is a multidimensional pattern that includes a plurality of component,
said computing the first probability comprises:
computing a probability of said virtual pattern existing between said input pattern and said learning pattern for each of said plurality of component, as a probability element; and
computing a product of said probability element in said plurality of component, as said first probability, and
said computing said probability element comprises:
deciding the probability element corresponding to i^{th} component as 1, when said input pattern or said learning pattern is lost in said i^{th} component.

12. The pattern identifying program according to claim 11, wherein said computing said probability element comprises:
computing said probability element, based on a probability density function that is previously prepared for each of said plurality of component.

13. The pattern identifying program according to claim 12, wherein said probability density function is a function that indicates a probability of existence of randomly generated data.

14. The pattern identifying program according to claim 12, wherein said probability density function is a function that indicates a probability of existence of data that is generated to be distributed with uniformity.

15. A pattern identifying device, comprising:
a data inputting means for reading, as data, an input pattern to be identified and a learning pattern previously prepared;
a first probability computing means for computing a probability of a virtually generated virtual pattern existing between said input pattern and said learning pattern, as a first probability;
a non-similarity computing means for computing a non-similarity of said input pattern with respect to said learning pattern, based on said first probability; and
an identifying means for identifying whether or not said input pattern is consistent with said learning pattern, based on said non-similarity.

16. The pattern identifying device according to claim 15, wherein said non-similarity computing means is configured to compute a logarithm of said first probability as said non-similarity.

17. The pattern identifying device according to claim 15, wherein said non-similarity computing means is configured to compute said first probability itself as said non-similarity.

18. The pattern identifying device according to claim 15, wherein said data inputting means is configured to read a multidimensional pattern that includes a plurality of component, as each of said input pattern, said learning pattern and said virtual pattern,
said first probability computing means comprises:
a probability element computing means for computing a probability of said virtual pattern existing between said input pattern and said learning pattern for each of said plurality of component, as a probability element; and
a multiplying means for computing a product of said probability element in said plurality of component, as said first probability, and
said probability element computing means is configured to decide the probability element corresponding to i^{th} component as 1, when said input pattern or said learning pattern is lost in said i^{th} component.

19. The pattern identifying device according to claim 18, wherein said probability element computing means is configured to compute said probability element, based on a probability density function that is previously prepared for each of said plurality of component.

20. The pattern identifying device according to claim 19, wherein said probability density function is a function that indicates a probability of existence of randomly generated data.

21. The pattern identifying device according to claim 19, wherein said probability density function is a function that indicates a probability of existence of data that is generated to be distributed with uniformity.
